(19) United States
(12) Patent Application Publication
(10) Pub. No.: US 2016/0012487 A1
(43) Pub. Date: Jan. 14, 2016

(54) DEVICE SITUATIONAL CONTEXT-BASED CONTENT DISPLAY

(71) Applicant: VERIZON PATENT AND LICENSING INC., Arlington, VA (US)

(72) Inventors: Brigitte BASTALDO-TSAMPALIS, Bridgewater, NJ (US); Yuk Lun LI, Morganville, NJ (US); Ning ZHANG, Warren, NJ (US)

(21) Appl. No.: 14/327,938

(22) Filed: Jul. 10, 2014

(51) Int. Cl. G06Q 30/02

(52) U.S. Cl. CPC G06Q 30/0267

(57) ABSTRACT

Systems and methods for device situational context-based content display are described. Some implementations include receiving a current situational context of a mobile station, determining, a level of satisfaction of a display condition of a content item stored at the content server with respect to the received current situational context of the mobile station, wherein the display condition of the content item defines for which situational context the content item is to be displayed at the mobile station, determining, at the content server, whether the determined level of satisfaction of the display condition is greater than a predefined threshold level of satisfaction of the display condition, and when the determined level of satisfaction of the display condition of the content item is greater a predefined threshold level of satisfaction of the display condition, providing the content item for display from the content server to the mobile station.

### BACKGROUND

In recent years, the use of mobile devices, such as smartphones, has significantly increased. Users share and consume a considerable amount of content (e.g., audio, video, advertisements, etc.) via their mobile devices. Content provided to mobile devices is generally tied to a user profile or identification of a user using the mobile device. A profile refers to a digital representation of a person's identity. A profile can be used to store a description of characteristics of the person and is generally formed over a period of time. This information can be leveraged by systems taking into account the person's characteristics and preferences. Content provided to the user is generally personalized for a user based on the user's profile. Some users may have privacy-related concerns with respect to such profiling or identification. As a result, such users may be averse to receiving content based on such profiling. Users may also occasionally lend their device to another user (e.g., friend or coworker). In this scenario, the other user may continue to receive content tailored for the original user's profile. This may degrade user experience for the other user while potentially causing an invasion of privacy of the original user.

As the foregoing illustrates, a new approach for providing content to users on mobile devices with consideration to such concerns may be desirable.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates a high-level functional block diagram of an example of a system of networks/devices that provide various communications for mobile stations and support an example of the device situational context-based content display service.

FIG. 2 illustrates exemplary changes in situational context of a mobile station.

FIG. 3 illustrates an exemplary process of display of content on a mobile station in accordance with the disclosed implementations.

FIG. 4 illustrates an exemplary flow and architecture diagram in accordance with the disclosed implementations.

FIG. 5 illustrates exemplary fees that may be received from an entity before the entity is allowed to provide a display bid to the content server of FIG. 1.

FIG. 6 illustrates a high-level functional block diagram of an exemplary non-touch type mobile station as may utilize the device situational context-based content display service through a network/system like that shown in FIG. 1.

FIG. 7 illustrates a high-level functional block diagram of an exemplary touch screen type mobile station as may utilize the device situational context-based content display service through a network/system like that shown in FIG. 1.

FIG. 8 illustrates a simplified functional block diagram of a computer that may be configured as a host or server, for example, to function as the content server in the system of FIG. 1.

FIG. 9 illustrates a simplified functional block diagram of a personal computer or other work station or terminal device.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The disclosed implementations relate to device situational context-based content display. The disclosed implementations display content items based on a situational context of a mobile station independent of (or without regard to) a user profile or identification of a user using the mobile station. The content items may include, but are not limited to, web applications, audio, video, images, advertisements, coupons or any combination thereof. The situational context may include, but is not limited to, an orientation of the mobile station, a location of the mobile station or environmental conditions in proximity to the mobile station. In this way, a personalized user experience need not be tied to user identification or a user profile. This can improve a user's perception of the user's network privacy. Furthermore, when the user lends the user's device to another user (e.g., friend or coworker), the other user need not continue to receive content items tailored for the original user's profile. In some implementations, the other user may select an option via a user interface of the mobile station to indicate that that other user would not want to continue to receive content items tailored for the original user's profile. Instead, the user may receive content based on the situational context of the device. This can improve user experience for the other user and improves privacy for the original user because the other user may not view content personalized and intended for the original user.

Reference now is made in detail to the examples illustrated in the accompanying drawings and discussed below.

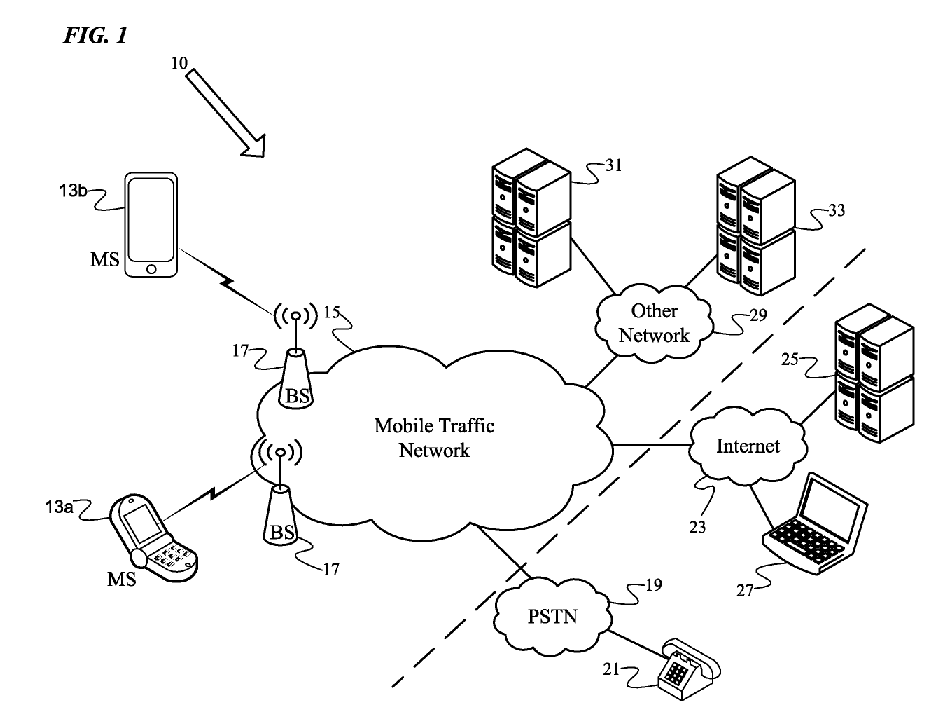

FIG. 1 illustrates a system 10 offering a variety of mobile communication services, including communications for device situational context-based content display provided to mobile station users. The example shows simply two mobile stations (MSs) 13a and 13b as well as a mobile communication network 15. The stations 13a and 13b are examples of mobile stations that may be used for the device situational context-based content display service. However, the network will provide similar communications for many other similar users as well as for mobile devices/users that do not participate in the device situational context-based content display service. The network 15 provides mobile wireless communications services to those stations as well as to other mobile stations (not shown), for example, via a number of base stations (BSs) 17. The present techniques may be implemented in any of a variety of available mobile networks 15 and/or on any type of mobile station compatible with such a network 15, and the drawing shows only a very simplified example of a few relevant elements of the network 15 for purposes of discussion here.

The wireless mobile communication network 15 might be implemented as a network conforming to the code division multiple access (CDMA) IS-95 standard, Long Term Evolution (LTE), the 3rd Generation Partnership Project 2 (3GPP2) wireless IP network standard or the Evolution Data Optimized (EVDO) standard, the Global System for Mobile (GSM) communication standard, a time division multiple access (TDMA) standard or other standards used for public mobile wireless communications. The mobile stations 13a and 13b are capable of voice telephone communications through the network 15, and for the device situational context-based content display service, the exemplary devices 13a and 13b are capable of data communications through the particular type of network 15 (and the users thereof typically will have subscribed to data service through the network).

The network 15 allows users of the mobile stations such as 13a and 13b (and other mobile stations not shown) to initiate and receive telephone calls to each other as well as through the public switched telephone network or “PSTN” 19 and telephone stations 21 connected to the PSTN. The network 15 typically offers a variety of data services via the Internet 23, such as downloads, web browsing, email, etc. By way of example, the drawing shows a laptop PC type user terminal 27 as well as a server 25 connected to the Internet 23; and the data services for the mobile stations 13 via the Internet 23 may be with devices like those shown at 25 and 27 as well as with a variety of other types of devices or systems capable of data communications through various interconnected networks. Users of the device situational context-based content display service also can receive and execute applications written in various programming languages, as discussed more later.

Mobile stations 13a and 13b can take the form of portable handsets, smart-phones or personal digital assistants, although they may be implemented in other form factors. Program applications, including an application to assist in the device situational context-based content display service and/or any an application provided via the on-line device situational context-based content display service can be configured to execute on many different types of mobile stations 13a and 13b. For example, a mobile station application can be written to execute on a binary runtime environment for mobile (BREW-based) mobile station, a Windows Mobile based mobile station, Android, I-Phone, Java Mobile, or RIM based mobile station such as a BlackBerry or the like. Some of these types of devices can employ a multi-tasking operating system.

The mobile communication network 10 can be implemented by a number of interconnected networks. Hence, the overall network 10 may include a number of radio access networks (RANs), as well as regional ground networks interconnecting a number of RANs and a wide area network (WAN) interconnecting the regional ground networks to core network elements. A regional portion of the network 10, such as those serving mobile stations 13a and 13b, can include one or more RANs and a regional circuit and/or packet switched network and associated signaling network facilities.

Physical elements of a RAN operated by one of the mobile service providers or carriers, include a number of base stations represented in the example by the base stations (BSs) 17. Although not separately shown, such a base station 17 can include a base transceiver system (BTS), which can communicate via an antennae system at the site of base station and over the airlink with one or more of the mobile stations 13a and 13b, when the mobile stations are within range. Each base station can include a BTS coupled to several antennae mounted on a radio tower within a coverage area often referred to as a “cell.” The BTS is the part of the radio network that sends and receives RF signals to/from the stations 13a and b that are served by the base station 17.

The radio access networks can also include a traffic network represented generally by the cloud at 15, which carries the user communications and data for the stations 13a and b between the base stations 17 and other elements with or through which the mobile stations communicate. The network can also include other elements that support functionality other than device-to-device media transfer services such as messaging service messages and voice communications. Specific elements of the network 15 for carrying the voice and data traffic and for controlling various aspects of the calls or sessions through the network 15 are omitted here form simplicity. It will be understood that the various network elements can communicate with each other and other aspects of the mobile communications network 10 and other networks (e.g., the public switched telephone network (PSTN) and the Internet) either directly or indirectly.

The carrier will also operate a number of systems that provide ancillary functions in support of the communications services and/or application services provided through the network 10, and those elements communicate with other nodes or elements of the network 10 via one or more private IP type packet data networks 29 (sometimes referred to as an Intranet), i.e., a private networks. Generally, such systems are part of or connected for communication via the private network 29. A person skilled in the art, however, would recognize that systems outside of the private network could serve the same functions as well. Examples of such systems, in this case operated by the network service provider as part of the overall network 10, which communicate through the intranet type network 29, include one or more application servers 31 and a related authentication server 33 for the application service of server 31.

A mobile station 13 communicates over the air with a base station 17 and through the traffic network 15 for various voice and data communications, e.g. through the Internet 23 with a server 25 and/or with application servers 31. If the mobile service carrier offers the device situational context-based content display service, the service may be hosted on a carrier operated content server 31, for communication via the networks 15 and 29. Alternatively, the device situational context-based content display service may be provided by a separate entity (alone or through agreements with the carrier), in which case, the service may be hosted on an application server such as server 25 connected for communication via the networks 15 and 23. Servers such as 25 and 31 may provide any of a variety of common application or service functions in support of or in addition to an application program running on the mobile station 13. However, for purposes of further discussion, we will focus on functions thereof in support of the device situational context-based content display service. For a given service, including the context-based content display service, an application program within the mobile station may be considered as a ‘client’ and the programming at 25 or 31 may be considered as the ‘server’ application for the particular service.

To insure that the application service offered by server 31 is available to only authorized devices/users, the provider of the application service also deploys an authentication server 33. The authentication server 33 could be a separate physical server as shown, or authentication server 33 could be implemented as another program module running on the same hardware platform as the content server 31. Essentially, when the server application (server 31 in our example) receives a service request from a client application on a mobile station 13, the server application provides appropriate information to the authentication server 33 to allow server application 33 to authenticate the mobile station 13 as outlined herein. Upon successful authentication, the server 33 informs the content server 31, which in turn provides access to the service via data communication through the various communication elements (e.g. 29, 15 and 17) of the network 10. A similar authentication function may be provided for device situational context-based content display service(s) offered via the server 25, either by the server 33 if there is an appropriate arrangement between the carrier and the operator of server 24, by a program on the server 25 or via a separate authentication server (not shown) connected to the Internet 23.

In some implementations, a current situational context of mobile station 13a is received at the content server 31. As noted above, the situational context can include, but is not limited to, an orientation of the mobile station 13a, a location of the mobile station 13a, environmental conditions in proximity to the mobile station 13a or one or more recent actions performed by the user using the mobile station 13a. The one or more recent actions may include online purchases or other user interactions performed by the user within a pre-determined period of time (e.g., one minute, two minutes, one hour, etc.). The current situational context of the mobile station 13a determined at a particular instance in time may be automatically transmitted by the mobile station 13a at when it is determined. Automatically determining and transmitting the current situational context may be repeated at predetermined intervals. In some implementations, the current situation context may be transmitted as a data array (over network 15) including one or more values of orientation of the mobile station 13a, a location of the mobile station 13a, environmental conditions in proximity to the mobile station 13a or one or more recent actions performed by the user using the mobile station 13a. The data array may be read by the content server 31 when the data array is received at the content server 31.

The mobile station 13a and web-enabled devices in general are capable of determining their orientation; that is, they can report data indicating changes to their orientation with relation to the pull of gravity. In particular, hand-held devices such as mobile phones can use this information to automatically rotate the display to remain upright, presenting a wide-screen view of the web content when the device is rotated so that its width is greater than its height. In some implementations, the orientation of the mobile station 13a may be determined using a device orientation application programming interface (API) resident at the mobile station 13a. For example, the content server 31 may query an orientation API of the mobile station 13a to determine whether the mobile station 13a is oriented in a landscape or a portrait mode.

The mobile station 13a can be capable of determining its own geographic location. For example, the mobile station 13a can include a Global Positioning System (GPS) module that determines a latitude and longitude of the mobile station 13a. In some implementations, the content server 31 may query a geo-location API of the mobile station 13a to determine a geographic location of the mobile station 13a.

The mobile station 13a can be capable of determining environmental conditions. For example, the mobile station 13a can include a temperature sensor to determine the temperature in proximity to the mobile station 13a. In some implementations, the content server 31 may query an environmental API of the mobile station 13a to determine environmental conditions in the proximity of the mobile station 13a.

The mobile station 13a may be capable of determining one or more recent actions performed by a user of the mobile station 13a. For example, one or more recent actions performed by the user may be stored in a memory of the mobile station 13a. The recent actions may include online store purchases made by the user or visits to a physical store at a geographic location. As used herein the term “recent” can include actions performed by the user within a particular period of time measured from when a request for the one or more recent actions performed by the user is made by the content server 31. For example, recent actions may refer to actions performed within one minute, two hours, etc. before the time of the determining of one or more recent actions performed by a user of the mobile station 13a. These time periods are purely illustrative and are not intended to limit the disclosed embodiments.

In some implementations, the orientation of the mobile station, a location of the mobile station, environmental conditions in proximity to the mobile station or one or more recent actions performed by the user using the mobile station can be received at the content server 31 from the mobile station 13a. The content server 31 can then determine a level of satisfaction of a display condition of a content item of one or more content items stored at the content server with respect to the received current situational context of the mobile station. The determination of a level of satisfaction of a display item is discussed further below. The display condition of the content item can define for which situational context the content item is to be displayed at the mobile station, where the display condition is independent of profile information associated with a particular user. A profile refers to a digital representation of a person's identity. The profile information may include one or more of a name of a person, an address of the person, age of the person or any personally identifiable information.

In some implementations, prior to providing a content item for display to the mobile station 13a, the content server 31 may compare a determined level of satisfaction of the display condition of the content item to a level of satisfaction of the display condition of a different content item stored at the server. For example, a condition “(a) the mobile station is at a geographic location of a coffee shop” can be satisfied but the condition “(b) the coffee shop is known to redeem coupons” may not be satisfied. However, at the same time, for an airline flight information application, a display condition that the content item is displayed when the user is at a geographic location associated with an airport may be satisfied. In this scenario, the content server 31 may compare the determined level of satisfaction of the coffee shop coupon's condition to that of the airline flight information application. The content server 31 may determine that the display condition of the airline flight information application is greater than the determined level of satisfaction of the display condition of the coffee store coupon (both stored at the content server 31). The content server 31 may then prioritize the display of the airline flight information application over the coffee coupon at the mobile station 13a. In this way, when the determined level of satisfaction of the display condition of a content item is greater than the determined level of satisfaction of the display condition of a different content item stored at the content server 31, the content server 31 prioritizes the display of the content item over the different content item at the mobile station 13a. As a result of the prioritization, the coffee coupon may not be displayed. However, the airline flight information application may be displayed. Such prioritization may include, but is not limited to, displaying the prioritized content item at a larger size than the other content item(s) or even displaying the prioritized content item instead of the larger content item. For example, the prioritized content item may be displayed at the above or below web page content in a browser of the mobile station 13a.

Content items may be displayed in a grid type format, a one at a time format or any other format. In another example, the content may be displayed as a pop-up that may fade out from display. In some implementations, where the content items include one or more of mobile applications, videos, images, coupons or audio, the content items may be prioritized based on their respective types. For example, videos may be prioritized over images, mobile applications may be prioritized over video and audio, etc. As the number of content items to be displayed increases, respective dimensions of the content items may be reduced. As the number of content items to be displayed reduces, respective dimensions of the content items may be increased. These examples are purely illustrative and are not intended to limit the implementations.

In some implementations, to determine whether the mobile station is at the coffee shop, geographic coordinates of the mobile station 13a may be determined by a GPS device in the mobile station 13a. The geographic coordinates may be compared to a database of geographic coordinates that may be associated with certain entities (e.g., businesses). Then, for example, if the coordinates of the mobile station are the coordinates associated with the coffee shop, it may be determined that the mobile station is at the coffee shop. Additionally, it may be determined whether the coffee shop is a coffee shop that redeems coupons. This may be determined by checking the identified coffee shop against a database of coffee shops that accept coupons. This example is illustrative and is not intended to limit the disclosed implementations. In another example, where the content item is an airline flight information application, the display condition may indicate that the content item is to be displayed when the user is at a geographic location associated with an airport. In yet another example, the content item may be an advertisement to be displayed at a particular time of the day based on one or more conditions. For example, if the temperature in proximity to the mobile station is determined to be higher than a particular value (e.g., 80 F), an advertisement for ice cream may be provided for display to the mobile station 13a by the content server 31. In some implementations, the advertisement may be from ice cream shops located in geographic vicinity of the mobile station 13a.

In some implementations, before the content items are provided to the mobile station 13a for display, the content server 31 determines whether the determined level of satisfaction of the display condition is greater than a predefined threshold level of satisfaction of the display condition. For example, with reference to the coffee shop example noted above, the predefined threshold level of satisfaction may be met when (a) the mobile station is at a coffee shop (b) the coffee shop is known to redeem coupons. In other words both (a) and (b) may need to be satisfied to meet the threshold level of satisfaction causing the content server 31 to provide the coupon for display to the mobile station 13a. In this way, when the determined level of satisfaction of the display condition of the content item is greater a predefined threshold level of satisfaction of the display condition, the content server 31 can provide the content item for display from the content server to the mobile station 13a. It is to be appreciated that the term “satisfaction” as used herein refers to the satisfaction of the conditions and not satisfaction of user.

In some implementations, when the determined level of satisfaction of the display condition of the content item is less than the predefined threshold level of satisfaction of the display condition, the content server 31 may determine, whether a level of satisfaction associated with another content item stored at the content server 31 is greater than the predefined threshold level. When the determined level of satisfaction of the display condition of the other content item is greater than the predefined threshold level of satisfaction of the display condition, the content server 31 provides the other content item for display from the content server 31 to the mobile station 13a. For example, for the coffee shop example noted above, the conditions of “(a) the mobile station is at a geographic location of a coffee shop that redeems the coupon” can be satisfied but the condition “(b) the coffee shop is known to redeem coupons” may not be satisfied. However, at the same time (assuming that the user is at an airport having a coffee shop) for airline flight information application, the display condition that the content item is displayed when the user is at a geographic location associated with an airport may be satisfied. In this scenario, the content server 31 may determine that the condition associated with the coffee coupon does not have a level of satisfaction greater than a threshold level of satisfaction and may display the airline information application whose display condition has met and/or exceeded the threshold level of satisfaction.

In some implementations, the content server 31 may receive from the mobile station 13a, an updated situational context of the mobile station 31. The updated situational context of the mobile station 13a can include, but is not limited to, an updated orientation of the mobile station 13a, an updated location of the mobile station, updated environmental conditions in proximity to the mobile station 13a or new actions performed by the user using the mobile station. The updated situational context may be received at any time or location. For example, the updated situational context may be received automatically from the mobile station 13a at predetermined intervals of time or when the device location changes. The device location may change based on a predetermined distance. The predetermined distance can be, for example, a few feet and may be stored in memory at the mobile station 13a.

The content server 31 may then determine a level of satisfaction of the display condition of a particular content item of the one or more content items stored at the content server with respect to the received updated situational context of the mobile station. The content server 31 may then provide the particular content item for display based on the determination of whether the determined level of satisfaction of the display condition for the particular content item is greater than a predefined threshold level of satisfaction of the display condition.

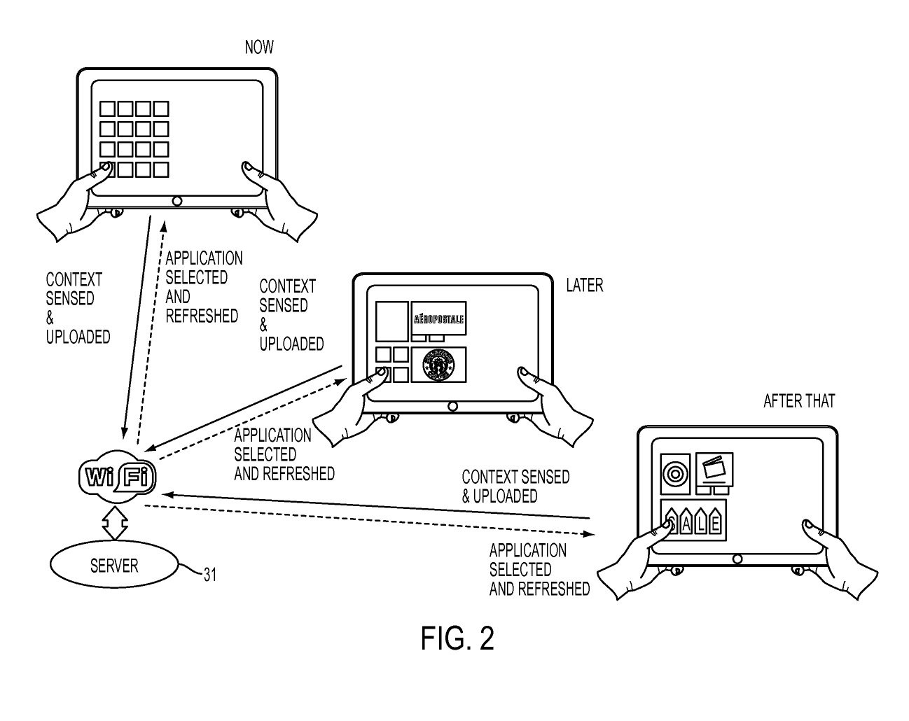

FIG. 2 illustrates exemplary changes in situational context of the mobile station 13a. For example, at different times (e.g., now, later and after), the situational context of the mobile station 13a has changed. As discussed earlier, the updated situational context may be received at any time or location. For example, the updated situational context may be received automatically at pre-determined intervals of time or when the device location changes. The content server 31 may then provide content item(s) for display based on the determination of whether the determined level of satisfaction of the display condition for the particular content item is greater than a predefined threshold level of satisfaction of the display condition. As shown in FIG. 2 different content items are provided for display as the situational context of the mobile station 13a changes over time. In this way, a personalized user experience need not be tied to user identification or a user profile. This can improve a user's perception of the user's network privacy. Furthermore, when the user lends the user's device to another user (e.g., friend or coworker), the other user need not continue to receive content items tailored for the original user's profile. Instead, the user may receive content based on the situational context of the device. This can improve user experience for the other user and improves privacy for the original user because the other user may not view content personalized and intended for the original user.

In some implementations, the content server 31 determines a display bid value associated with the content item. The display bid value can define a price an entity (e.g., advertisers, app developers, etc.) may pay for display of the content item at the mobile station 13a. The display bid value may be determined from a display bid database at the content server 31. As an illustrative example, a typical bid transaction may begin when a situational context of the mobile station 13a is received at the content server 31. This triggers a bid request to the content server 31. The request goes from the content server 31 to a bid exchange module in the content server 31, which submits the request and the accompanying data to multiple entities who automatically submit bids periodically (e.g., at predetermined hourly or minute intervals) to place their content items at the mobile station 13a. Entities may bid on each content item display as it is served by the content server 31 to the mobile station 13a. The impression (or display) of a content item goes to the highest bidder and their content item is displayed on the mobile station 13a. This process may be repeated for every display area on the mobile station 13a.

In some implementations, when the determined level of satisfaction of the display condition of the content item is greater a predefined threshold level of satisfaction of the display condition and the display bid value is greater than display bid values provided for the content item by other entities, the content server 31 provides the content item for display on behalf of the entity to the mobile station 13a. For example, if a weather application is to be displayed on the mobile station 13a, and if the display bid value provided by entity A is greater than that of entities B, C and D, then the weather application will be displayed at the mobile station 13a with a logo or branding of the entity A. In another example, if a weather application is to be displayed on the mobile station 13a, and if the display bid value provided by entity C is greater than that of entities A, B and D, then the weather application will be displayed at the mobile station 13a with a logo or branding of the entity C.

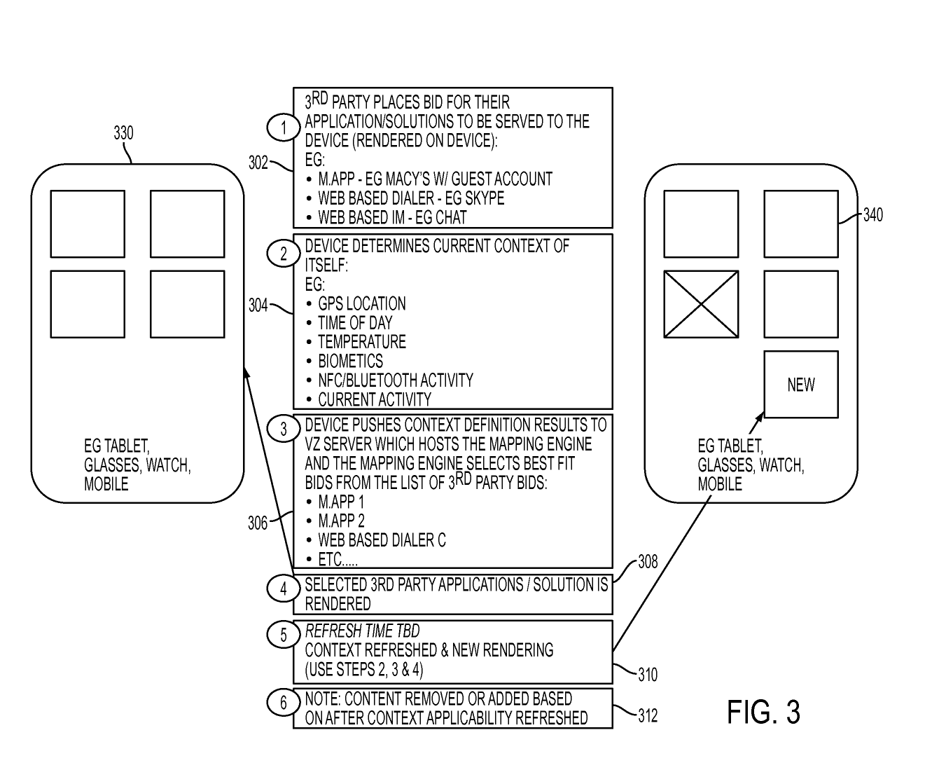

FIG. 3 illustrates an exemplary process of display of content on the mobile station 13a. Initially, different entities may place bids for content items at the content server 31 (step 302). As noted above, the display bid value can define a price an entity will pay for display of the content item at the mobile station. The mobile station 13a determines a current situational context of the mobile station 13a (step 304). The current situational context may be automatically determined at predetermined intervals or when new display bids are placed and received at the content server 31. The current situational context can include, but is not limited, to, geographic location of the mobile station 13a, the time of the day, temperature, biometric information, near-field communication (NFC) or Bluetooth activity or any other current activity at the mobile station 13a.

The mobile station 13a then provides the current situational context to the content server 31 (step 306). The current situational context may be provided as a context definition file or a data structure. Such a data structure may be an array. An array data structure or simply an array is a data structure consisting of a collection of elements (values or variables), each identified by at least one array index or key. One example of an array can be a list. Each piece of data in a list may be identified by an index number representing its position in the list. The list may be zero based, which means that the first element in the array is [0], the second element is [1], and so on. This example is illustrative and is not intended to limit the disclosed implementations. In this scenario, the different elements of the array may be the different context situational parameters, such as, geographic location of the mobile station 13a, the time of the day, temperature, biometric information, near-field communication (NFC) or Bluetooth activity or any other current activity at the mobile station 13a. In step 306, the context server 31 may also select a bid that best fits with the current situational context of the mobile station 13a.

As noted in the example above, in some implementations, when the determined level of satisfaction of the display condition of the content item is greater a predefined threshold level of satisfaction of the display condition and the display bid value is greater than display bid values provided for the content item by other entities, the content server 31 provides the content item for display on behalf of the entity to the mobile station 13a (step 308). Interface 330 represents a display state of the mobile station 13a based on a current situation context of the mobile station 13a and after step 308. Interface 302 displays four content items (e.g., web applications, coupons, images, ads, etc.). The content items may be displayed on behalf of the same entity or different entities based on the current situational context of the mobile station 13a and the display bids provided by the entities. When the situational context of the mobile station 13a is updated (step 310) (or after a predetermined amount of time), the steps 304 through 308 may be repeated and new content items may be rendered for display on the mobile station 13a (step 312). Interface 340 is a new rendering of content items at the mobile station 13a. In interface 340, one content item from the previous interface 330 has been removed and a new content item has been rendered for display at the mobile station 13a. In this way, displayed content items may automatically and periodically change based on changes to a situational context of the mobile station 13a. In some implementations, the frequency and duration for which the content items are displayed may be set at the mobile station 13a, the content server 31 or any client user interface. A number of content items that are to be displayed may also be set at the mobile station 13a, the content server 31 or any client user interface.

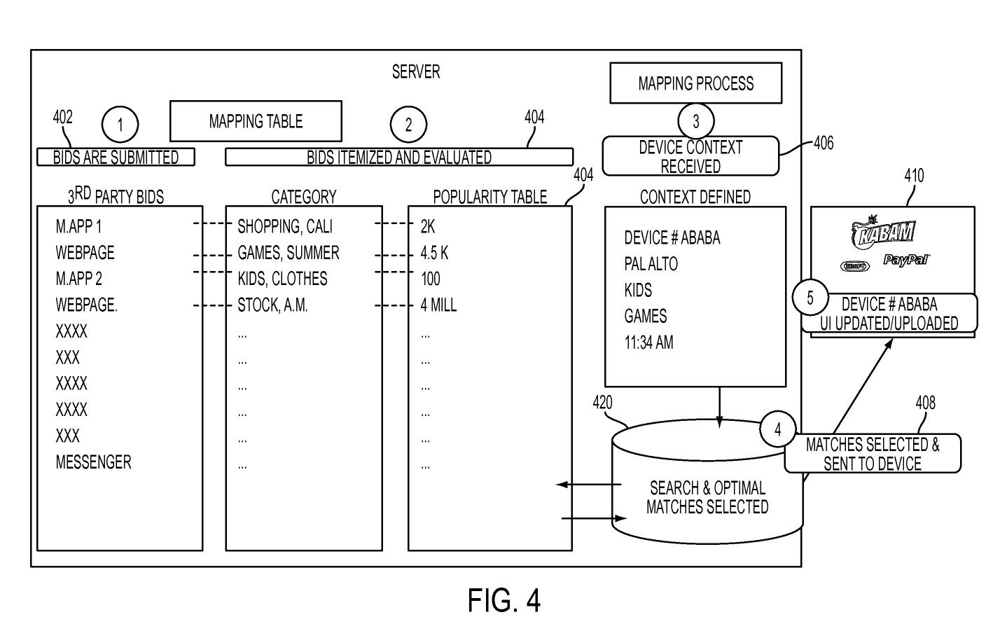

FIG. 4 illustrates an example flow and architecture diagram. In some implementations, when the content server 31 receives the display bid value from an entity (step 402), the content server 31 may categorize the display bid into one or more categories (step 404). The categories may indicate a type of content item for which the display bid is to be associated. For example, the categories may include automotive, clothing, gaming, art, food, etc. The content server 31 may then determine a popularity of the categories into which the display bid is categorized with respect to a plurality of users. For example, the content server 31 may determine that the food category is liked or preferred by more users of mobile stations than the automotive category. Such data may be obtained based on anonymized user preference numerical counts based on data provided by users when signing up for a particular service with the wireless network provider servicing the mobile station 13a. For example, the content server 31 may have access to data in a database that indicates that one hundred thousand users prefer the clothing category while twenty thousand users prefer the gaming category. No information identifying any user is included. The bids, categories and the popularity values may be stored in respective database mapping tables or data arrays at the content server 31. The content server 31 may then define the display condition based at least in part on the categorizing and the determined popularity. The content server 31 may define a minimum bid value that must be met before the display condition is satisfied based on the categorizing. For example, a display bid categorized into a more popular category may need to be higher to satisfy a display condition in comparison to a display bid categorized into a lower popularity category. This may be because popular categories may be associated with higher minimum bid values. Less popular categories may be associated with lower minimum bid values.

The current situational context of the mobile station 13a may be received in step 406. The current situational context may be received as a data array that also includes a device identifier (e.g., device #ABABA) among other parameters (e.g., location (Los Angeles), time, etc.) Referring to FIG. 4 the display condition may be stored in database 420 from where it may be retrieved by the content server 31 for comparison (step 408) (or matching/mapping) with the current situational context of the mobile station 13a received in step 406. Content items are then provided to the mobile station 13a (or any device identified by the device identifier) for display (step 410). Steps 406 and 408 may together be called as a mapping process by content server 31.

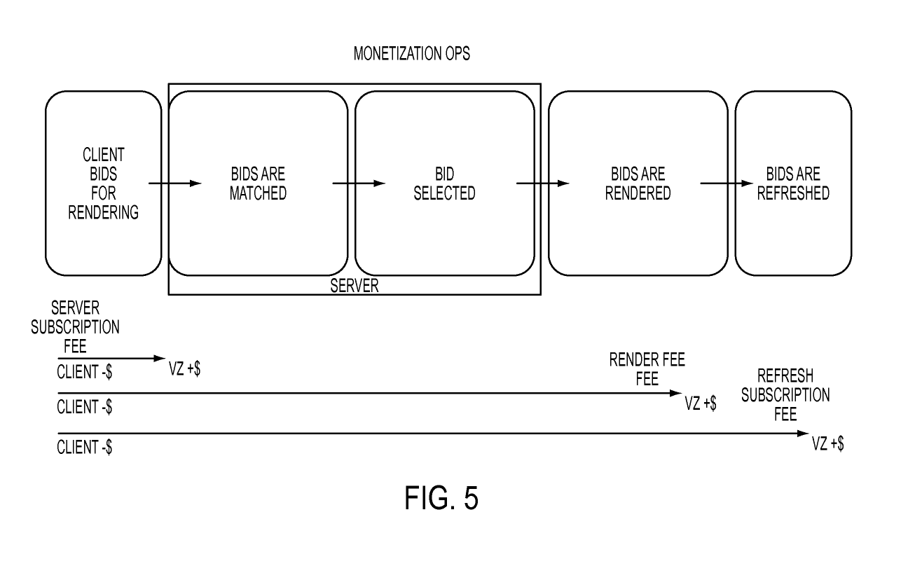

In some implementations and with reference to FIG. 5 the content server 31 may request a fee from an entity before the entity is allowed to provide a display bid to the content server 31. The content server 31 may then match the bid with the current situational context of the mobile station 13a and then, as discussed above, select a content item for display at the mobile station 13a. In some implementations, the bid or fee may be monetary. In other implementations, the bid fee may be non-monetary or based on a pre-determined non-monetary agreement. In some implementations, one or more entities may offer combined bids. For example, a first entity and second entity may make a single combined bid. Furthermore, when content items are displayed based on combined bids, respective times, device types/numbers, locations, etc., for which the content items may be displayed are based may be split based on a monetary or non-monetary contribution of each entity involved in the combined bid. The entity on behalf of which the content item is to be displayed (or any other entity) is charged a fee at the time of display of the content item at the mobile station 13a. When the current situational context of the mobile station 13a changes and one or more new content items are displayed, the entity may again be charged a refresh subscription fee. The entity may pre-enroll in a content item display subscription plan and then may incur fees based on terms defined in the plan. This increases revenue for a wireless network provider administering the plan.

The enhanced device situational context-based content display service under consideration here may be delivered to touch screen type mobile stations as well as to non-touch type mobile stations. Hence, our simple example shows the mobile station (MS) 13a as a non-touch type mobile station and shows the mobile station (MS) 13 as a touch screen type mobile station. Implementation of the service will involve at least some execution of programming in the mobile stations as well as implementation of user input/output functions and data communications through the network 15, from the mobile stations.

Those skilled in the art presumably are familiar with the structure, programming and operations of the various types of mobile stations. However, for completeness, it may be useful to consider the functional elements/aspects of two exemplary mobile stations 13a and 13b, at a high-level.

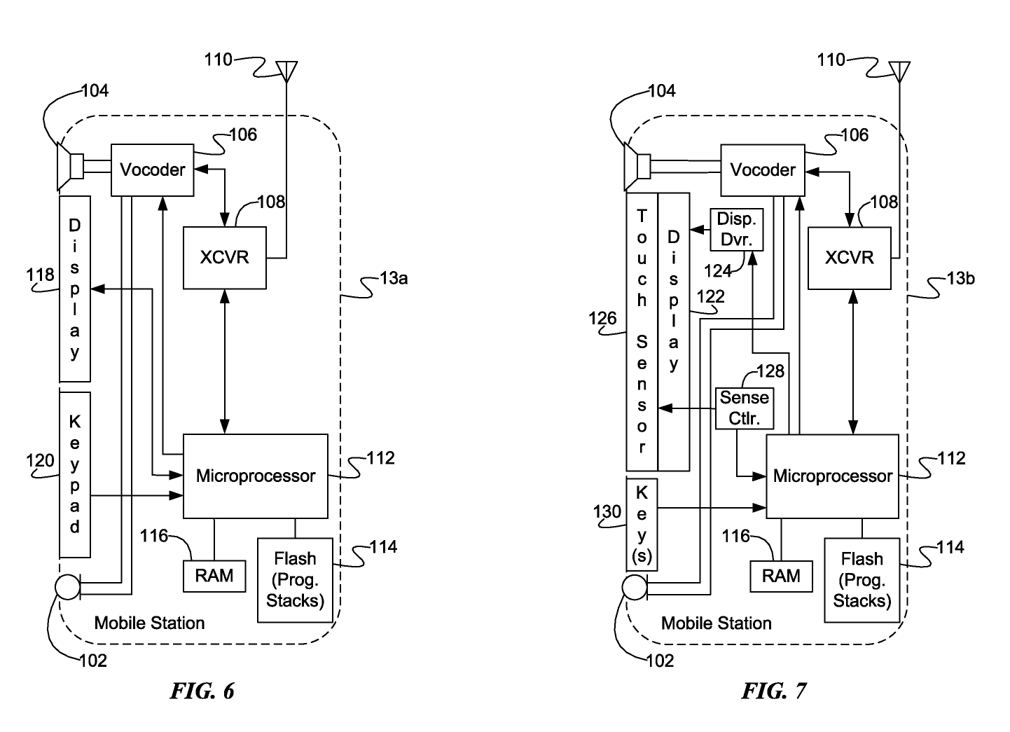

For purposes of such a discussion, FIG. 6 provides a block diagram illustration of an exemplary non-touch type mobile station 13a. Although the mobile station 13a may be a smart-phone or may be incorporated into another device, such as a personal digital assistant (PDA) or the like, for discussion purposes, the illustration shows the mobile station 13a is in the form of a handset. The handset embodiment of the mobile station 13a functions as a normal digital wireless telephone station. For that function, the station 13a includes a microphone 102 for audio signal input and a speaker 104 for audio signal output. The microphone 102 and speaker 104 connect to voice coding and decoding circuitry (vocoder) 106. For a voice telephone call, for example, the vocoder 106 provides two-way conversion between analog audio signals representing speech or other audio and digital samples at a compressed bit rate compatible with the digital protocol of wireless telephone network communications or voice over packet (Internet Protocol) communications.

For digital wireless communications, the handset 13a also includes at least one digital transceiver (XCVR) 108. Today, the handset 13a would be configured for digital wireless communications using one or more of the common network technology types. The concepts discussed here encompass embodiments of the mobile station 13a utilizing any digital transceivers that conform to current or future developed digital wireless communication standards. The mobile station 13a may also be capable of analog operation via a legacy network technology.

The transceiver 108 provides two-way wireless communication of information, such as vocoded speech samples and/or digital information, in accordance with the technology of the network 15. The transceiver 108 also sends and receives a variety of signaling messages in support of the various voice and data services provided via the mobile station 13a and the communication network. Each transceiver 108 connects through RF send and receive amplifiers (not separately shown) to an antenna 110. The transceiver may also support various types of mobile messaging services, such as short message service (SMS), enhanced messaging service (EMS) and/or multimedia messaging service (MMS).

The mobile station 13a includes a display 118 for displaying messages, menus or the like, call related information dialed by the user, calling party numbers, etc., including content provided by the device situational context-based content display. A keypad 120 enables dialing digits for voice and/or data calls as well as generating selection inputs, for example, as may be keyed-in by the user based on a displayed menu or as a cursor control and selection of a highlighted item on a displayed screen. The display 118 and keypad 120 are the physical elements providing a textual or graphical user interface. Various combinations of the keypad 120, display 118, microphone 102 and speaker 104 may be used as the physical input output elements of the graphical user interface (GUI), for multimedia (e.g., audio and/or video) communications. Of course other user interface elements may be used, such as a trackball, as in some types of PDAs or smart phones.

In addition to normal telephone and data communication related input/output (including message input and message display functions), the user interface elements also may be used for display of menus and other information to the user and user input of selections, including any needed during device situational context-based content display.

A microprocessor 112 serves as a programmable controller for the mobile station 13a, in that it controls all operations of the mobile station 13a in accord with programming that it executes, for all normal operations, and for operations involved in device situational context-based content display under consideration here. In the example, the mobile station 13a includes flash type program memory 114, for storage of various “software” or “firmware” program routines and mobile configuration settings, such as mobile directory number (MDN) and/or mobile identification number (MIN), etc. The mobile station 13a may also include a non-volatile random access memory (RAM) 116 for a working data processing memory. Of course, other storage devices or configurations may be added to or substituted for those in the example. In a present implementation, the flash type program memory 114 stores firmware such as a boot routine, device driver software, an operating system, call processing software and vocoder control software, and any of a wide variety of other applications, such as client browser software and short message service software. The memories 114, 116 also store various data, such as telephone numbers and server addresses, downloaded data such as multimedia content, and various data input by the user. Programming stored in the flash type program memory 114, sometimes referred to as “firmware,” is loaded into and executed by the microprocessor 112.

As outlined above, the mobile station 13a includes a processor, and programming stored in the flash memory 114 configures the processor so that the mobile station is capable of performing various desired functions, including in this case the functions involved in the technique for providing device situational context-based content display.

For purposes of such a discussion, FIG. 7 provides a block diagram illustration of an exemplary touch screen type mobile station 13b. Although possible configured somewhat differently, at least logically, a number of the elements of the exemplary touch screen type mobile station 13b are similar to the elements of mobile station 13a, and are identified by like reference numbers in FIG. 7. For example, the touch screen type mobile station 13b includes a microphone 102, speaker 104 and vocoder 106, for audio input and output functions, much like in the earlier example. The mobile station 13b also includes at least one digital transceiver (XCVR) 108, for digital wireless communications, although the handset 13b may include an additional digital or analog transceiver. The concepts discussed here encompass embodiments of the mobile station 13b utilizing any digital transceivers that conform to current or future developed digital wireless communication standards. As in the station 13a, the transceiver 108 provides two-way wireless communication of information, such as vocoded speech samples and/or digital information, in accordance with the technology of the network 15. The transceiver 108 also sends and receives a variety of signaling messages in support of the various voice and data services provided via the mobile station 13b and the communication network. Each transceiver 108 connects through RF send and receive amplifiers (not separately shown) to an antenna 110. The transceiver may also support various types of mobile messaging services, such as short message service (SMS), enhanced messaging service (EMS) and/or multimedia messaging service (MMS).

As in the example of station 13a, a microprocessor 112 serves as a programmable controller for the mobile station 13b, in that it controls all operations of the mobile station 13b in accord with programming that it executes, for all normal operations, and for operations involved in the device situational context-based content display procedure under consideration here. In the example, the mobile station 13b includes flash type program memory 114, for storage of various program routines and mobile configuration settings. The mobile station 13b may also include a non-volatile random access memory (RAM) 116 for a working data processing memory. Of course, other storage devices or configurations may be added to or substituted for those in the example. Hence, outlined above, the mobile station 13b includes a processor, and programming stored in the flash memory 114 configures the processor so that the mobile station is capable of performing various desired functions, including in this case the functions involved in the technique for providing device situational context-based content display.

In the example of FIG. 6, the user interface elements included a display and a keypad. The mobile station 13b may have a limited number of key 130, but the user interface functions of the display and keypad are replaced by a touchscreen display arrangement. At a high level, a touchscreen display is a device that displays information to a user and can detect occurrence and location of a touch on the area of the display. The touch may be an actual touch of the display device with a finger, stylus or other object, although at least some touchscreens can also sense when the object is in close proximity to the screen. Use of a touchscreen display as part of the user interface enables a user to interact directly with the information presented on the display.

Hence, the exemplary mobile station 13b includes a display 122, which the microprocessor 112 controls via a display driver 124, to present visible outputs to the device user. The mobile station 13b also includes a touch/position sensor 126. The sensor 126 is relatively transparent, so that the user may view the information presented on the display 122. A sense circuit 128 sensing signals from elements of the touch/position sensor 126 and detects occurrence and position of each touch of the screen formed by the display 122 and sensor 126. The sense circuit 128 provides touch position information to the microprocessor 112, which can correlate that information to the information currently displayed via the display 122, to determine the nature of user input via the screen.

The display 122 and touch sensor 126 (and possibly one or more keys 130, if included) are the physical elements providing the textual and graphical user interface for the mobile station 13b. The microphone 102 and speaker 104 may be used as additional user interface elements, for audio input and output, including with respect to some functions related to device situational context-based content display.

The structure and operation of the mobile stations 13a and 13b, as outlined above, were described to by way of example, only.

As shown by the above discussion, functions relating to the device situational context-based content display service, via a graphical user interface of a mobile station may be implemented on computers connected for data communication via the components of a packet data network, operating as a content server as shown in FIG. 1. Although special purpose devices may be used, such devices also may be implemented using one or more hardware platforms intended to represent a general class of data processing device commonly used to run “server” programming so as to implement the device situational context-based content display functions discussed above, albeit with an appropriate network connection for data communication.

As known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g. files used for device situational context-based content display. The software code is executable by the general-purpose computer that functions as the content server and/or that functions as a mobile terminal device (e.g., the mobile station 13a). In operation, the code is stored within the general-purpose computer platform. At other times, however, the software may be stored at other locations and/or transported for loading into the appropriate general-purpose computer system. Execution of such code by a processor of the computer platform enables the platform to implement the methodology for device situational context-based content display, in essentially the manner performed in the implementations discussed and illustrated herein.

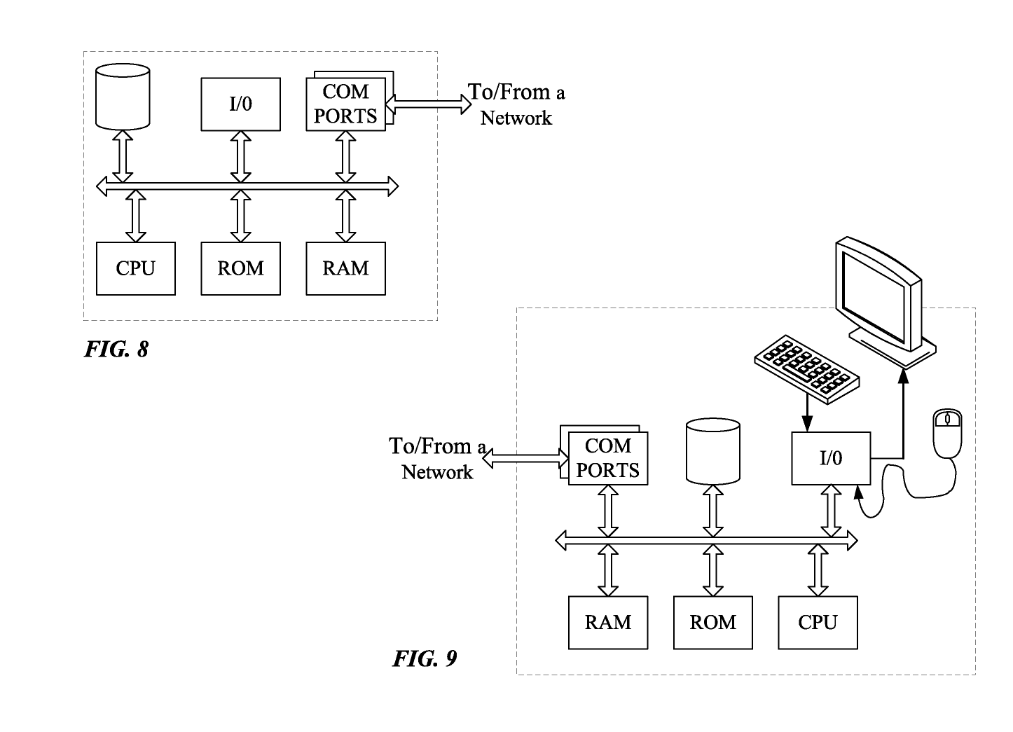

FIGS. 8 and 9 provide functional block diagram illustrations of general purpose computer hardware platforms. FIG. 5 illustrates a network or host computer platform, as may typically be used to implement a server. FIG. 6 depicts a computer with user interface elements, as may be used to implement a personal computer or other type of work station or terminal device, although the computer of FIG. 6 may also act as a server if appropriately programmed. It is believed that those skilled in the art are familiar with the structure, programming and general operation of such computer equipment and as a result the drawings should be self-explanatory.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. Of course, the server functions may be implemented in a distributed fashion on a number of similar platforms, to distribute the processing load.

A computer type user terminal device, such as a PC or tablet computer, similarly includes a data communication interface CPU, main memory and one or more mass storage devices for storing user data and the various executable programs (see FIG. 6). A mobile station type user terminal may include similar elements, but will typically use smaller components that also require less power, to facilitate implementation in a portable form factor. The various types of user terminal devices will also include various user input and output elements. A computer, for example, may include a keyboard and a cursor control/selection device such as a mouse, trackball, joystick or touchpad; and a display for visual outputs. A microphone and speaker enable audio input and output. Some smartphones include similar but smaller input and output elements. Tablets and other types of smartphones utilize touch sensitive display screens, instead of separate keyboard and cursor control elements. The hardware elements, operating systems and programming languages of such user terminal devices also are conventional in nature, and it is presumed that those skilled in the art are adequately familiar therewith.

Hence, aspects of the methods of device situational context-based content display outlined above may be embodied in programming. Program aspects of the technology may be thought of as “products” or “articles of manufacture” typically in the form of executable code and/or associated data that is carried on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of a wireless network provider into the computer platform of the device situational context-based content display that will be the content server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the device situational context-based content display service, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
receiving, at a content server from a mobile station, a current situational context of the mobile station, wherein the situational context includes at least one of an orientation of the mobile station, a location of the mobile station, environmental conditions in proximity to the mobile station or one or more recent actions performed by the user using the mobile station;
determining, at the content server, a level of satisfaction of a display condition of a content item of one or more content items stored at the content server with respect to the received current situational context of the mobile station, wherein the display condition of the content item defines for which situational context the content item is to be displayed at the mobile station, wherein the display condition is independent of profile information associated with a particular user;
determining, at the content server, whether the determined level of satisfaction of the display condition is greater than a predefined threshold level of satisfaction of the display condition; and
when the determined level of satisfaction of the display condition of the content item is greater a predefined threshold level of satisfaction of the display condition, providing the content item for display from the content server to the mobile station.

2. The method of claim 1, further comprising:
comparing the determined level of satisfaction of the display condition of the content item to a level of satisfaction of the display condition of a different content item stored at the server; and
when the determined level of satisfaction of the display condition of the content item is greater than the determined level of satisfaction of the display condition of the different content item stored at the server, prioritizing the display of the content item over the different content item at the mobile station.

3. The method of claim 1, further comprising:
when the determined level of satisfaction of the display condition of the content item is less than the predefined threshold level of satisfaction of the display condition, determining, at the content server, whether a level of satisfaction associated with another content item stored at the content server is greater than the predefined threshold level; and
when the determined level of satisfaction of the display condition of the other content item is greater than the predefined threshold level of satisfaction of the display condition, providing the other content item for display from the content server to the mobile station.

4. The method of claim 1, further comprising:
receiving, at the content server from a mobile station, an updated situational context of the mobile station, wherein the updated situational context includes at least one of an updated orientation of the mobile station, an updated location of the mobile station, updated environmental conditions in proximity to the mobile station or new actions performed by the user using the mobile station;
determining, at the content server, a level of satisfaction of the display condition of a particular content item of the one or more content items stored at the content server with respect to the received updated situational context of the mobile station; and
providing the particular content item for display based on the determination of whether the determined level of satisfaction of the display condition for the particular content item is greater than a predefined threshold level of satisfaction of the display condition.

5. The method of claim 1, further comprising:
determining a display bid value associated with the content item, wherein the display bid value defines a price an entity will pay for display of the content item at the mobile station; and
when the determined level of satisfaction of the display condition of the content item is greater a predefined threshold level of satisfaction of the display condition and the display bid value is greater than display bid values provided for the content item by other entities, providing the content item for display on behalf of the entity to the mobile station.

6. The method of claim 5, further comprising:
receiving the display bid value from an entity;
categorizing the display bid into one or more categories;
determining a popularity of the categories into which the display bid is categorized with respect to a plurality of users; and
defining the display condition based at least in part on the categorizing and the determined popularity.

7. The method of claim 1, further comprising:
updating the displayed content item with another content item based on a refresh setting, wherein the refresh setting defines how long a content item is to be displayed regardless of updates to the situational context of the mobile station.

8. The method of claim 1, wherein the content items include one or more of mobile applications, videos, images, coupons or audio.

9. A content server comprising:
a communication interface configured to enable communication via a mobile network;
a processor coupled with the communication interface;
a storage device accessible to the processor; and
an executable program in the storage device, wherein execution of the program by the processor configures the server to perform functions, including functions to:
receive, at a content server from a mobile station, a current situational context of the mobile station, wherein the situational context includes at least one of an orientation of the mobile station, a location of the mobile station, environmental conditions in proximity to the mobile station or one or more recent actions performed by the user using the mobile station;
determine, at the content server, a level of satisfaction of a display condition of a content item of one or more content items stored at the content server with respect to the received current situational context of the mobile station, wherein the display condition of the content item defines for which situational context the content item is to be displayed at the mobile station, wherein the display condition is independent of profile information associated with a particular user;
determine, at the content server, whether the determined level of satisfaction of the display condition is greater than a predefined threshold level of satisfaction of the display condition; and
when the determined level of satisfaction of the display condition of the content item is greater a predefined threshold level of satisfaction of the display condition, provide the content item for display from the content server to the mobile station.

10. The content server of claim 9, wherein execution of the program by the processor configures the server to perform functions, including functions to:
compare the determined level of satisfaction of the display condition of the content item to a level of satisfaction of the display condition of a different content item stored at the server; and
when the determined level of satisfaction of the display condition of the content item is greater than the determined level of satisfaction of the display condition of the different content item stored at the server, prioritize the display of the content item over the different content item at the mobile station.

11. The content server of claim 9, wherein execution of the program by the processor configures the server to perform functions, including functions to:
when the determined level of satisfaction of the display condition of the content item is less than the predefined threshold level of satisfaction of the display condition, determine, at the content server, whether a level of satisfaction associated with another content item stored at the content server is greater than the predefined threshold level; and
when the determined level of satisfaction of the display condition of the other content item is greater than the predefined threshold level of satisfaction of the display condition, provide the other content item for display from the content server to the mobile station.

12. The content server of claim 9, wherein execution of the program by the processor configures the server to perform functions, including functions to:
receiving, at the content server from a mobile station, an updated situational context of the mobile station, wherein the updated situational context includes at least one of an updated orientation of the mobile station, an updated location of the mobile station, updated environmental conditions in proximity to the mobile station or new actions performed by the user using the mobile station;
determining, at the content server, a level of satisfaction of the display condition of a particular content item of the one or more content items stored at the content server with respect to the received updated situational context of the mobile station; and
providing the particular content item for display based on the determination of whether the determined level of satisfaction of the display condition for the particular content item is greater than a predefined threshold level of satisfaction of the display condition.

13. The content server of claim 9, wherein execution of the program by the processor configures the server to perform functions, including functions to:
determining a display bid value associated with the content item, wherein the display bid value defines a price an entity will pay for display of the content item at the mobile station; and
when the determined level of satisfaction of the display condition of the content item is greater a predefined threshold level of satisfaction of the display condition and the display bid value is greater than display bid values provided for the content item by other entities, providing the content item for display on behalf of the entity to the mobile station.

14. The content server of claim 13, wherein execution of the program by the processor configures the server to perform functions, including functions to:
receive the display bid value from an entity;
categorize the display bid into one or more categories;
determine a popularity of the categories into which the display bid is categorized with respect to a plurality of users; and
define the display condition based at least in part on the categorizing and the determined popularity.

15. The content server of claim 9, wherein execution of the program by the processor configures the server to perform functions, including functions to:
updating the displayed content item with another content item based on a refresh setting, wherein the refresh setting defines how long a content item is to be displayed regardless of updates to the situational context of the mobile station.

16. The content server of claim 9, wherein the content items include one or more of mobile applications, videos, images, coupons or audio.

17. A non-transitory computer-readable medium comprising instructions which, when executed by one or more computers, cause the one or more computers to:
receive, at a content server from a mobile station, a current situational context of the mobile station, wherein the situational context includes at least one of an orientation of the mobile station, a location of the mobile station, environmental conditions in proximity to the mobile station or one or more recent actions performed by the user using the mobile station;
determine, at the content server, a level of satisfaction of a display condition of a content item of one or more content items stored at the content server with respect to the received current situational context of the mobile station, wherein the display condition of the content item defines for which situational context the content item is to be displayed at the mobile station, wherein the display condition is independent of profile information associated with a particular user;
determine, at the content server, whether the determined level of satisfaction of the display condition is greater than a predefined threshold level of satisfaction of the display condition; and
when the determined level of satisfaction of the display condition of the content item is greater a predefined threshold level of satisfaction of the display condition, provide the content item for display from the content server to the mobile station.

18. The computer-readable medium of claim 17 further comprising instructions which, when executed by the one or more computers, cause the one or more computers to:
compare the determined level of satisfaction of the display condition of the content item to a level of satisfaction of the display condition of a different content item stored at the server; and
when the determined level of satisfaction of the display condition of the content item is greater than the determined level of satisfaction of the display condition of the different content item stored at the server, prioritize the display of the content item over the different content item at the mobile station.

19. The computer-readable medium of claim 17 further comprising instructions which, when executed by the one or more computers, cause the one or more computers to:
when the determined level of satisfaction of the display condition of the content item is less than the predefined threshold level of satisfaction of the display condition, determine, at the content server, whether a level of satisfaction associated with another content item stored at the content server is greater than the predefined threshold level; and
when the determined level of satisfaction of the display condition of the other content item is greater than the predefined threshold level of satisfaction of the display condition, provide the other content item for display from the content server to the mobile station.

20. The computer-readable medium of claim 17 further comprising instructions which, when executed by the one or more computers, cause the one or more computers to:
receiving, at the content server from a mobile station, an updated situational context of the mobile station, wherein the updated situational context includes at least one of an updated orientation of the mobile station, an updated location of the mobile station, updated environmental conditions in proximity to the mobile station or new actions performed by the user using the mobile station;
determining, at the content server, a level of satisfaction of the display condition of a particular content item of the one or more content items stored at the content server with respect to the received updated situational context of the mobile station; and
providing the particular content item for display based on the determination of whether the determined level of satisfaction of the display condition for the particular content item is greater than a predefined threshold level of satisfaction of the display condition.
